(19) United States
(12) Patent Application Publication
(10) Pub. No.: US 2018/0176968 A1
(43) Pub. Date: Jun. 21, 2018

(54) APPARATUS, METHODS AND COMPUTER PROGRAMS FOR ESTABLISHING WIRELESS CONNECTIONS

(71) Applicant: Nokia Technologies Oy, Espoo (FI)

(72) Inventors: Jukka Reunamaki, Tampere (FI); Arto Palin, Viiala (FI)

(73) Assignee: Nokia Technologies Oy, Espoo (FI)

(21) Appl. No.: 15/128,482

(22) PCT Filed: Mar. 12, 2015
(86) PCT No.: PCT/FI2015/050156

§ 371 Date: Sep. 23, 2016

(51) Int. Cl. H04W 76/10; H04L 29/08; H04W 4/80; H04M 1/60; H04M 1/725

(52) U.S. Cl. CPC H04W 76/10; H04L 67/306; H04M 1/7253; H04M 1/6066; H04W 4/80

(57) ABSTRACT

An apparatus, method and computer program wherein the apparatus comprises: processing circuitry; and memory circuitry including computer program code; the memory circuitry and the computer program code configured to, with the processing circuitry, cause the apparatus at least to perform; causing a service to be provided using a first user device and an accessory device wherein the accessory device is connected to the first user device via a wireless connection and wherein a plurality of user devices are registered to a user account; obtaining status information from the first user device; and determining a trigger event has occurred and in response to determining that a trigger event has occurred, enabling a second user device to establish a wireless connection to the accessory device wherein the second user device is registered to the user account.

### TECHNOLOGICAL FIELD

Examples of the disclosure relate to apparatus, methods and computer programs for establishing wireless connections. In particular examples of the disclosure relate to apparatus, methods and computer programs for establishing wireless connections between an accessory device and different user devices.

### BACKGROUND

It is known for electronic devices to establish short range wireless networks. For example a user may connect a headset to a mobile phone or a gaming device or a tablet computer or any other suitable device. Sometimes a user may want to change the device connected to the headset or other accessory device. For instance the user may be listening to music using their phone and a headset but may want to connect the headset to a tablet so they can start to play a game. This may require the user to disconnect the accessory device from the first device and set up a connection with a second device. This procedure may include several steps including making the accessory device discoverable by the second device, identifying the accessory device and enabling the short range wireless connection to be established.

It would be useful to enable a user to easily switch the connections of their accessory devices between their different user devices.

### BRIEF SUMMARY

According to various but not necessarily all examples of the disclosure there may be provided an apparatus comprising: processing circuitry; and memory circuitry including computer program code; the memory circuitry and the computer program code configured to, with the processing circuitry, cause the apparatus at least to perform; causing a service to be provided using a first user device and an accessory device wherein the accessory device is connected to the first user device via a wireless connection and wherein a plurality of user devices are registered to a user account; obtaining status information from the first user device; and determining a trigger event has occurred and in response to determining that a trigger event has occurred, enabling a second user device to establish a wireless connection to the accessory device wherein the second user device is registered to the user account.

In some examples the obtained status information may be provided to the second user device to enable the second user device to establish a wireless connection to the accessory device.

In some examples after the wireless connection is established with the second user device the service may be provided using the second user device and the accessory device.

In some examples the status information may comprise information which enables the accessory device to be identified by the user devices.

In some examples the status information may comprise information relating to a service currently being provided by the first user device and the accessory device.

In some examples the apparatus may also obtain information relating to a performance level of the wireless connection between the first user device and the accessory device. The trigger event may comprise detecting that the wireless connection between the first user device and the accessory device falls below a predetermined level.

In some examples the trigger event may comprise obtaining information indicating that the user is using the second user device.

In some examples the trigger event may comprise a user input.

In some examples the wireless connection between the accessory device and the other devices may comprise a short range wireless connection.

In some examples the accessory device may comprise a wearable device.

In some examples the apparatus may be configured to be connected to the first and second user devices via an internet connection.

In some examples at least one of the first and second user devices may comprise a mobile device.

In some examples there may be provided a server comprising an apparatus as described above.

According to various but not necessarily all examples of the disclosure there may be provided a method comprising: causing a service to be provided using a first user device and an accessory device wherein the accessory device is connected to the first user device via a wireless connection and wherein a plurality of user devices are registered to a user account for; determining that a trigger event has occurred and in response to determining that a trigger event has occurred, enabling a second user device to establish a wireless connection to the accessory device wherein the second user device is registered to the user account.

In some examples the obtained status information may be provided to the second user device to enable the second user device to establish a wireless connection to the accessory device.

In some examples after the wireless connection is established with the second user device the service may be provided using the second user device and the accessory device.

In some examples the status information may comprise information which enables the accessory device to be identified by the user devices.

In some examples the status information may comprise information relating to a service currently being provided by the first user device and the accessory device.

In some examples the method may further comprise obtaining information relating to a performance level of the wireless connection between the first user device and the accessory device. The trigger event may comprise detecting that the performance level of the wireless connection between the first user device and the accessory device falls below a predetermined level.

In some examples the trigger event may comprise obtaining information indicating that the user is using the second user device.

In some examples the trigger event may comprise a user input.

In some examples the wireless connection between the accessory device and the other devices may comprise a short range wireless connection.

In some examples the accessory device may comprise a wearable device.

In some examples the apparatus may be configured to be connected to the first and second user devices via an internet connection.

In some examples at least one of the first and second user devices may comprise a mobile device.

According to various but not necessarily all examples of the disclosure there may be provided a computer program comprising computer program instructions that, when executed by processing circuitry, enable: causing a service to be provided using a first user device and an accessory device wherein the accessory device is connected to the first user device via a wireless connection and wherein a plurality of user devices are registered to a user account; obtaining status information from the first user device; and determining a trigger event has occurred and in response to determining that a trigger event has occurred, enabling a second user device to establish a wireless connection to the accessory device wherein the second user device is registered to the user account.

According to various but not necessarily all examples of the disclosure there may be provided a computer program comprising program instructions for causing a computer to perform the methods described above.

According to various but not necessarily all examples of the disclosure there may be provided a physical entity embodying the computer program as described above.

According to various but not necessarily all examples of the disclosure there may be provided an electromagnetic carrier signal carrying the computer program as described above.

According to various but not necessarily all examples of the disclosure there may be provided an apparatus comprising: processing circuitry; and memory circuitry including computer program code; the memory circuitry and the computer program code configured to, with the processing circuitry, cause the apparatus at least to perform; enabling a service to be provided using an accessory device wherein the accessory device is connected to the apparatus via a wireless connection and the service is enabled using a server and wherein a plurality of user devices are registered to a user account for the service; and providing status information to the server wherein the status information enables another user device, registered to the user account for the service, to establish a wireless connection to the accessory device.

In some examples after the wireless connection is established with the another user device the service may be provided using the another user device and the accessory device.

In some examples the status information may comprise information which enables the accessory device to be identified by user devices.

In some examples the status information may comprise information relating to a service currently being provided by the apparatus and the accessory device.

According to various but not necessarily all examples of the disclosure there may be provided a method comprising: enabling a service to be provided using an accessory device wherein the accessory device is connected to an apparatus via a wireless connection and the service is enabled using a server and wherein a plurality of user devices are registered to a user account for the service; and providing status information to the server wherein the status information enables another user device, registered to the user account for the service, to establish a wireless connection to the accessory device.

In some examples after the wireless connection is established with the another user device the service is provided using the another user device and the accessory device.

In some examples the status information may comprise information which enables the accessory device to be identified by user devices.

In some examples the status information may comprise information relating to a service currently being provided by the apparatus and the accessory device.

According to various but not necessarily all examples of the disclosure there may be provided a computer program comprising computer program instructions that, when executed by processing circuitry, enable: enabling a service to be provided using an accessory device wherein the accessory device is connected to an apparatus via a wireless connection and the service is enabled using a server and wherein a plurality of user devices are registered to a user account for the service; and providing status information to the server wherein the status information enables another user device, registered to the user account for the service, to establish a wireless connection to the accessory device.

According to various but not necessarily all examples of the disclosure there may be provided a computer program comprising program instructions for causing a computer to perform the methods described above.

According to various but not necessarily all examples of the disclosure there may be provided a physical entity embodying the computer program as claimed in any preceding claim.

According to various but not necessarily all examples of the disclosure there may be provided an electromagnetic carrier signal carrying the computer program as claimed in any preceding claim.

According to various but not necessarily all examples of the disclosure there may be provided an apparatus comprising: processing circuitry; and memory circuitry including computer program code; the memory circuitry and the computer program code configured to, with the processing circuitry, cause the apparatus at least to perform; enabling communication with a server wherein the server is configured to cause a service to be provided using a first user device and an accessory device wherein the accessory device is connected to the first user device via a wireless connection and wherein a plurality of user devices are registered to a user account for the service: obtaining status information from the server; and determining that a trigger event has occurred and in response to determining that a trigger event has occurred establishing a wireless connection to the accessory device.

In some examples the obtained status information may comprise information which is used to enable the wireless connection to be established.

In some examples after the wireless connection is established with the apparatus the service may be provided using the apparatus and the accessory device.

In some examples the status information may comprise information which enables the accessory device to be identified by user devices.

In some examples the status information may comprise information relating to a service currently being provided by the apparatus and the accessory device.

According to various but not necessarily all examples of the disclosure there may be provided a method comprising: enabling communication with a server wherein the server is configured to cause a service to be provided using a first user device and an accessory device wherein the accessory device is connected to the first user device via a wireless connection and wherein a plurality of user devices are registered to a user account for the service: obtaining status information from the server; and determining that a trigger event has occurred and in response to determining that a trigger event has occurred establishing a wireless connection to the accessory device.

In some examples the obtained status information may comprise information which is used to enable the wireless connection to be established.

In some examples after the wireless connection is established with the apparatus the service may be provided using the apparatus and the accessory device.

In some examples the status information may comprise information which enables the accessory device to be identified by user devices.

In some examples the status information may comprise information relating to a service currently being provided by the apparatus and the accessory device.

According to various but not necessarily all examples of the disclosure there may be provided a computer program comprising computer program instructions that, when executed by processing circuitry, enable: enabling communication with a server wherein the server is configured to cause a service to be provided using a first user device and an accessory device wherein the accessory device is connected to the first user device via a wireless connection and wherein a plurality of user devices are registered to a user account for the service: obtaining status information from the server; and determining that a trigger event has occurred and in response to determining that a trigger event has occurred establishing a wireless connection to the accessory device.

According to various but not necessarily all examples of the disclosure there may be provided a computer program comprising program instructions for causing a computer to perform the methods described above.

According to various but not necessarily all examples of the disclosure there may be provided a physical entity embodying the computer program as described above.

According to various but not necessarily all examples of the disclosure there may be provided an electromagnetic carrier signal carrying the computer program as described above.

According to various, but not necessarily all, examples of the disclosure there may be provided examples as claimed in the appended claims.

### BRIEF DESCRIPTION

For a better understanding of various examples that are useful for understanding the brief description, reference will now be made by way of example only to the accompanying drawings in which:

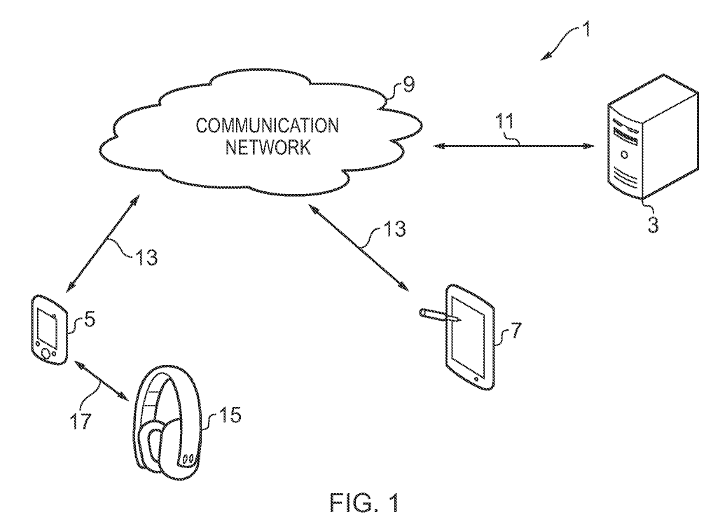

FIG. 1 illustrates a system;

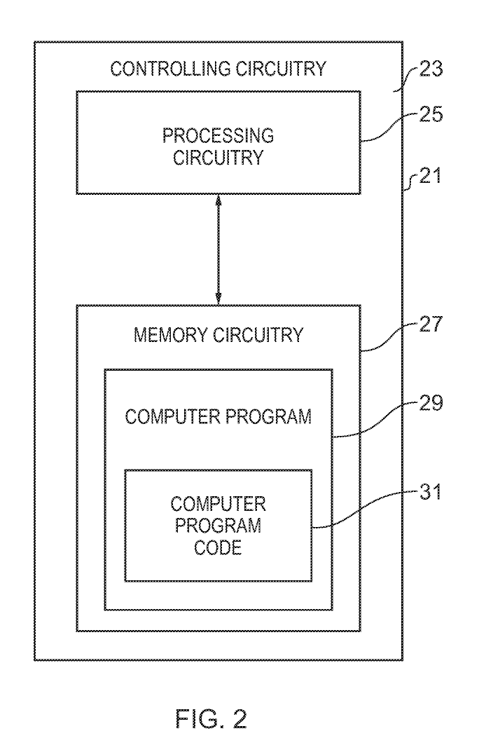

FIG. 2 illustrates an apparatus;

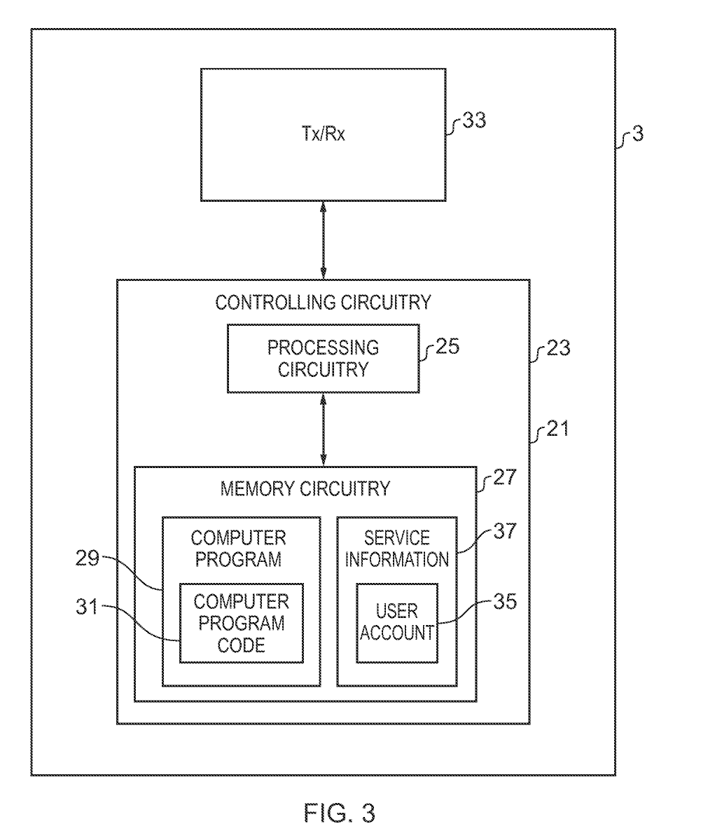

FIG. 3 illustrates a server;

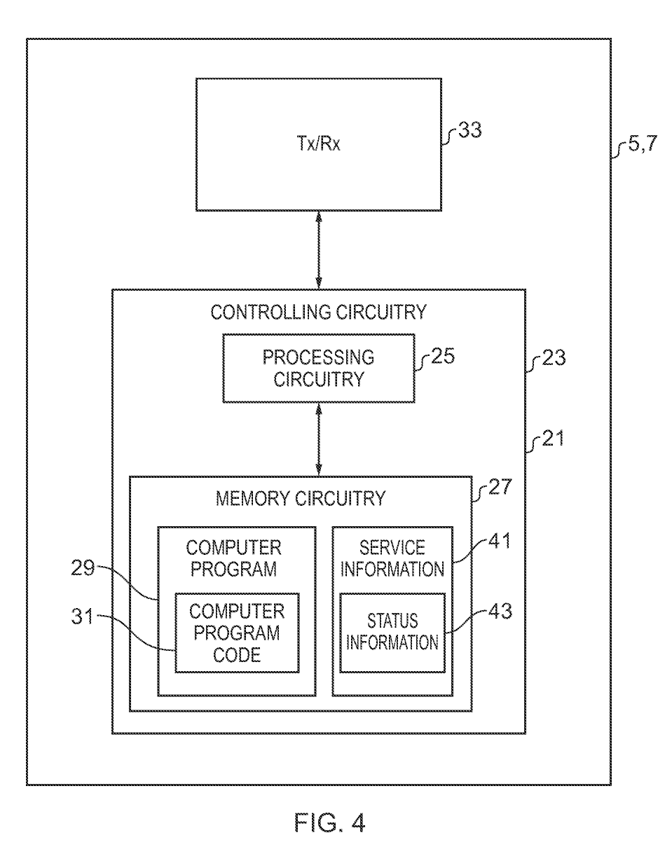

FIG. 4 illustrates a user device;

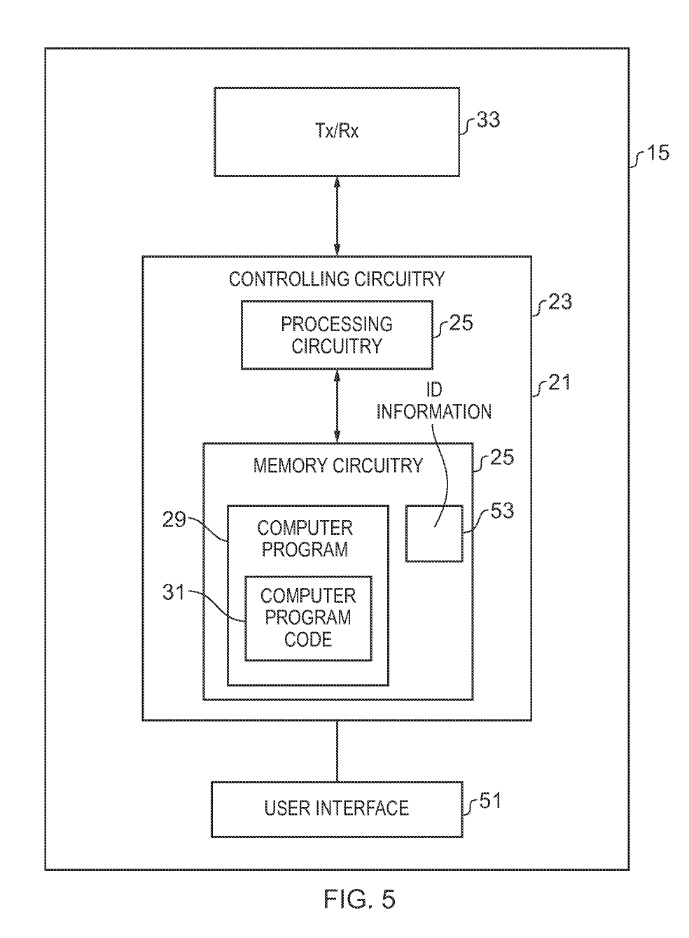

FIG. 5 illustrates an accessory device;

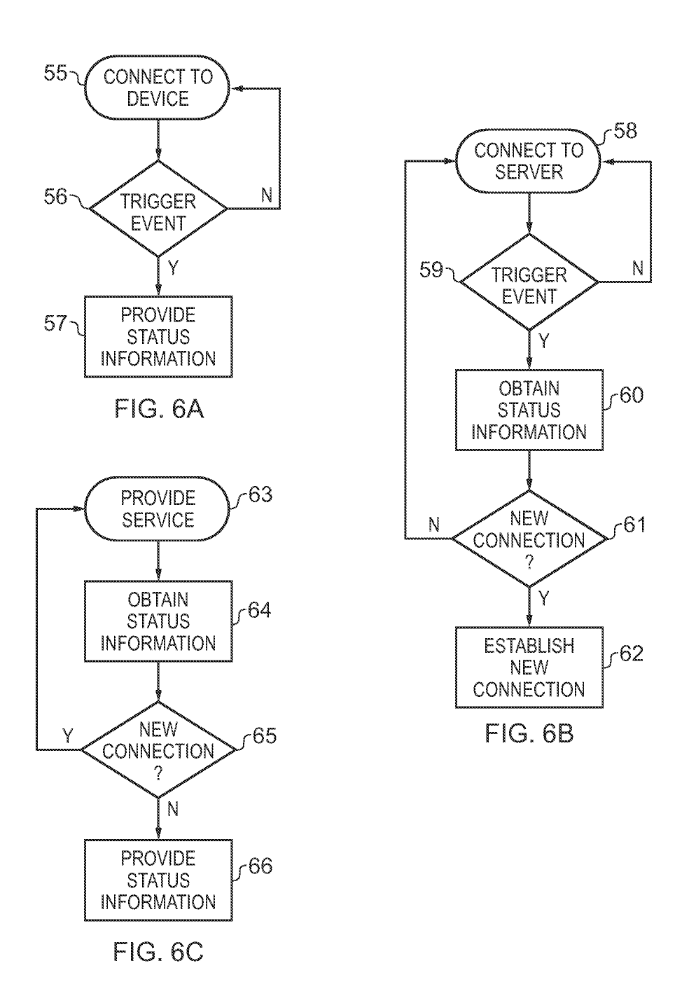

FIGS. 6A to 6C illustrate methods;

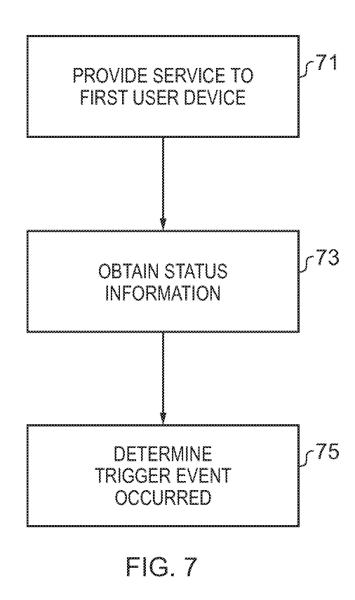

FIG. 7 illustrates a method;

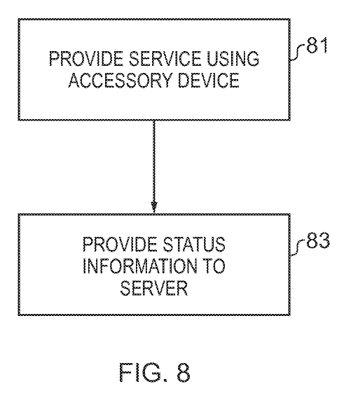

FIG. 8 illustrates a method; and

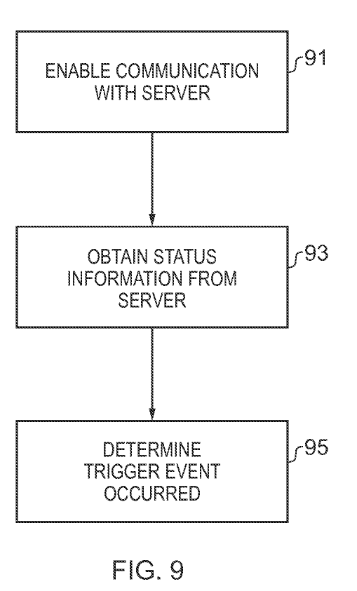

FIG. 9 illustrates a method.

### DETAILED DESCRIPTION

The Figures illustrate systems, apparatus and methods which may be used to enable switching an accessory device connection from a first user device to a second user device while a service is being provided using the user devices.

The Figures illustrate an apparatus 21 comprising: processing circuitry 25; and memory circuitry 27 including computer program code 31; the memory circuitry 27 and the computer program code 31 configured to, with the processing circuitry 25, cause the apparatus 21 at least to perform; causing a service to be provided using a first user device 5 and an accessory device 15 wherein the accessory device 15 is connected to the first user device 5 via a wireless connection 17 and wherein a plurality of user devices 5, 7 are registered to a user account 35; obtaining status information from the first user device 5; and determining a trigger event has occurred and in response to determining that a trigger event has occurred, enabling a second user device 7 to establish a wireless connection to the accessory device 15 wherein the second user device 7 is registered to the user account 35.

The example apparatus and systems of the Figures enable an accessory device 15 to be handed from a first user device 5 to a second user device 7 without interrupting the service being provided. This may enable a seamless handover between devices which the user of the service might not even notice.

FIG. 1 illustrates an example system 1 which may be used to implement examples of the disclosure.

In the example of FIG. 1 the system 1 comprises a server 3, two user devices 5, 7 and an accessory device 15. Examples of such servers 3 and devices 5, 7, 15 are illustrated in

FIGS. 2 to 5 and described in more detail below. It is to be appreciated that in other examples the system 1 may comprise a different number and/or arrangement of devices. For instance, in the system of FIG. 1 only one server 3 is illustrated however the functions of the server 3 may be distributed over a plurality of different servers. Similarly only two user devices 5, 7 are illustrated in FIG. 1 however, in other implementations the system 1 could comprise any number of different user devices 5, 7.

The server 3 may be located remotely from the user devices 5, 7 and the accessory device 15. The server 3 and the two user devices 5, 7 may be configured to communicate via a communication network 9. The communication network 9 may comprise any suitable communication network such as the internet.

The server 3 may be configured to enable a communication link 11 to be established between the server 3 and the communication network 9. The communication link 11 may comprise any means which enables information to be exchanged between the server 3 and the communication network 9. The communication link 11 may comprise a wired or wireless communication link.

The user devices 5, 7 may comprise any devices which may be associated with a user. The user devices 5, 7 may be registered to a user with a service provider. The user devices 5, 7 may be used to enable a service to be provided using the server 3. In the example system 1 of FIG. 1 the user devices 5, 7 comprise a mobile phone and a tablet computer. It is to be appreciated that other user devices 5, 7 may be used in other implementations.

The user devices 5, 7 may be configured to enable communication links 13 to be established between the user devices 5, 7 and the communication network 9. One or more of the communication links 13 between the user devices 5, 7 and the communication network 9 may comprise a wireless communication link. The wireless communication link could be a cellular communication link, a local area communication link, a Wi-Fi communication link any other suitable communication link. The wireless communication link may enable a user of the user device 5, 7 to change locations whilst maintaining a connection to the communication network 9.

The communication links 13 may comprise any means which enables information to be exchanged between the user devices 5, 7 and the communication network 9. As the server 3 is also connected to the communication network 9 this may enable the exchange of information between the server 3 and the user devices 5, 7. This may enable information and content relating to a service to be stored at the server 3 and made available to the user devices 5, 7. The server 3 may be configured to maintain a user account for one or more services. A plurality of user devices 5, 7 may be registered to the user account. This may enable different user devices 5, 7 to be used to access the same service. Examples of the disclosure may enable the server 3 to control a switch between providing a service using a first user device 5 and providing a service using a second user device 7. In particular, examples of the disclosure may enable the server 3 to control a switch between providing a service using a first user device 5 and providing a service using a second user device 7 where an accessory device 15 is used to provide an output to a user.

It is to be appreciated that user devices 5, 7 may be registered to more than one user account 35. This may enable examples of the disclosure to be implemented in different locations, such as the home and office of a user, using the same devices 5, 7.

The example system of FIG. 1 also comprises at least one accessory device 15. The accessory device 15 may comprise any device which comprises means for providing an output which may be used to enable a service to be provided to a user. In the example of FIG. 1 the accessory device 15 comprises a headset. It is to be appreciated that other accessory devices 15 may be used in other examples of the disclosure.

In the example of FIG. 1 a communication link 17 is established between a first user device 5 and the accessory device 15. The communication link 17 may comprise a wireless connection. The communication link 17 may comprise a short range wireless communication link such as a Bluetooth™ communication link or any other suitable connection. The communication link 17 may enable an output associated with the service provided to the first user device 5 to be provided to the user via the accessory device 15. For example, where the service being provided is a music providing service the first user device 5 may be configured to access the music content stored at the server 3 and provide a control signal to the accessory device 15 which causes the accessory device 15 to provide an acoustic signal to a user.

In the example system 1 of FIG. 1 a communication link 17 is established between the accessory device 15 and the first user device 5. In some circumstances it may be desirable to enable the accessory device 15 to switch the communication link to a different user device 7 so as to enable the accessory device 15 to be used with another user device 7. The examples below describe methods and apparatus which may be used to implement such a switch.

FIG. 2 schematically illustrates an example apparatus 21 which may be used in implementations of the disclosure. The apparatus 21 illustrated in FIG. 2 may be a chip or a chip-set. Example apparatus 21 may be provided within devices such as a server 3, a user device 5, 7 or an accessory device 15 or any other types of devices.

The example apparatus 21 comprises controlling circuitry 23. The controlling circuitry 23 may comprise one or more controllers. The controlling circuitry 23 may be implemented using instructions that enable hardware functionality, for example, by using executable computer program instructions in a general-purpose or special-purpose processing circuitry 25 that may be stored on a computer readable storage medium (disk, memory, memory circuitry 27 etc) to be executed by such processing circuitry 25.

The processing circuitry 25 may be configured to read from and write to memory circuitry 27. The processing circuitry 25 may comprise one or more processors. The processing circuitry 25 may also comprise an output interface via which data and/or commands are output by the processing circuitry 25 and an input interface via which data and/or commands are input to the processing circuitry 25.

The memory circuitry 27 may be configured to store a computer program 29 comprising computer program instructions (computer program code 31) that controls the operation of the apparatus 21 when loaded into processing circuitry 25. The computer program instructions, of the computer program 29, provide the logic and routines that enable the apparatus 21 to perform the example methods illustrated in FIGS. 6A to 9. The processing circuitry 25 by reading the memory circuitry 27 is able to load and execute the computer program 29.

The apparatus 21 therefore comprises: processing circuitry 25; and memory circuitry 27 including computer program code 31, the memory circuitry 27 and the computer program code 31 configured to, with the processing circuitry 25, cause the apparatus 21 at least to perform: causing a service to be provided using a first user device 5 and an accessory device 15 wherein the accessory device 15 is connected to the first user 5 device via a wireless connection 17 and wherein a plurality of user devices 5, 7 are registered to a user account 35; obtaining status information from the first user device 5; and determining a trigger event has occurred and in response to determining that a trigger event has occurred, enabling a second user device 7 to establish a wireless connection to the accessory device 15 wherein the second user device 7 is registered to the user account 35. Such apparatus 21 may be implemented in a server 3.

Alternative apparatus 21 may comprise: processing circuitry 25; and memory circuitry 27 including computer program code 31, the memory circuitry 27 and the computer program code 31 configured to, with the processing circuitry 25, cause the apparatus 21 at least to perform: enabling a service to be provided using an accessory device 15 wherein the accessory device 15 is connected to the apparatus via a wireless connection 17 and the service is enabled using a server 3 and wherein a plurality of user devices 5, 7 are registered to a user account 35 for the service; and providing status information to the server 3 wherein the status information enables another user device 7, registered to the user account 35 for the service, to establish a wireless connection to the accessory device 15. Such apparatus 21 may be implemented in a user device 5 which is handing over an accessory device 15.

Another alternative apparatus 21 may comprise: processing circuitry 25; and memory circuitry 27 including computer program code 31, the memory circuitry 27 and the computer program code 31 configured to, with the processing circuitry 25, cause the apparatus 21 at least to perform: enabling communication with a server wherein the server 3 is configured to cause a service to be provided using a first user device 5 and an accessory device 15 wherein the accessory device 15 is connected to the first user 5 device via a wireless connection 17 and wherein a plurality of user devices 5, 7 are registered to a user account 35 for the service: obtaining status information from the server 3; determining that a trigger event has occurred and in response to determining that the trigger event has occurred establishing a wireless connection to the accessory device 15. Such apparatus 21 may be implemented in a user device 7 which is taking over an accessory device 15.

The computer program 29 may arrive at the apparatus 21 via any suitable delivery mechanism. The delivery mechanism may be, for example, a non-transitory computer-readable storage medium, a computer program product, a memory device, a record medium such as a compact disc read-only memory (CD-ROM) or digital versatile disc (DVD), or an article of manufacture that tangibly embodies the computer program 29. The delivery mechanism may be a signal configured to reliably transfer the computer program 29. The apparatus 21 may propagate or transmit the computer program 29 as a computer data signal.

Although the memory circuitry 27 is illustrated as a single component in the figures it is to be appreciated that it may be implemented as one or more separate components some or all of which may be integrated/removable and/or may provide permanent/semi-permanent/dynamic/cached storage.

Although the processing circuitry 25 is illustrated as a single component in the figures it is to be appreciated that it may be implemented as one or more separate components some or all of which may be integrated/removable.

References to “computer-readable storage medium”, “computer program product”, “tangibly embodied computer program” etc. or a “controller”, “computer”, “processor”, “processing circuitry” etc. should be understood to encompass not only computers having different architectures such as single/multi-processor architectures and sequential (Von Neumann)/parallel architectures but also specialized circuits such as field-programmable gate arrays (FPGA), application-specific integrated circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” refers to all of the following:

(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example, and if applicable to the particular claim element, a baseband integrated circuit or applications processor integrated circuit for a mobile phone or a similar integrated circuit in a server, a cellular network device, or other network device.

FIG. 3 schematically illustrates an example server 3 which may be used in implementations of the disclosure. The server 3 may comprise an apparatus 21 and a transceiver 33. It is to be appreciated that only features necessary for the following description have been illustrated in FIG. 3. It is to be appreciated that other features may be used in other examples. In the example of FIG. 3 the server 3 is illustrated as a single entity. It is to be appreciated that in other examples the server 3 may be provided as a plurality of entities.

The server 3 may comprise any means which may enable a service to be provided to a user via a plurality of user devices 5, 7. The service could be a content rendering service. For instance the service could be a music or audio service which enables a user to download, store and listen to music or audio content using user devices 5, 7. In some examples the service may be a media service which enables a user to access video or television content or gaming content using different user devices 5, 7 or any other suitable service.

The apparatus 21 comprised within the server 3 of FIG. 3 may be as illustrated in FIG. 2 and described above. Corresponding reference numerals are used for corresponding features.

As described above the apparatus 21 comprises controlling circuitry 23. The controlling circuitry 23 comprises memory circuitry 27 and processing circuitry 25. The memory circuitry 27 may be configured to store a computer program 29 comprising computer program code 31.

The memory circuitry 27 may be configured to store service information 37. The service information 37 may comprise any information which may enable the same service to be provided using a plurality of user devices 5, 7. The server 3 may be configured to provide the same service to a plurality of user devices 5, 7. For instance the service information 37 may comprise content which may be stored on one or more servers 3 to enable the content to be synchronised and/or used by the different user devices 5, 7.

The service information 37 may also comprise one or more user accounts 35. A plurality of user devices 5, 7 may be registered to the user account 35. The user account 35 may enable a service to be provided to each user device 5, 7 which is registered to the user account 35. The user account 35 may comprise identification information relating to the user devices 5, 7. In some examples the user account 35 may comprise information relating to one or more accessory devices 15. The identification information may comprise information which may be used to establish a wireless connection between the user devices 5, 7 and one or more accessory devices 15. Such information may include for, instance a Bluetooth™ address, a shared secret (link key) information, pairing status information or any other suitable type of information.

In some examples information relating to the capabilities of the devices 5, 7, 15 may also be stored in the user account 35. Such information may include information such as the size and resolution of a display or the type and qualities of loudspeakers in an audio output device.

The transceiver 33 is illustrated as a single component in FIG. 3 however it is to be appreciated that the transceiver 33 may comprise one or more transmitters and/or receivers. The transceiver 33 may comprise any means which enables the server 3 to establish a communication link 11 with a communication network 9 and exchange information with the communication network 9. The communication link 11 may comprise a wireless connection.

The transceiver 33 may be configured to provide information obtained via the transceiver 33 to the controlling circuitry 23. The transceiver 33 may also be configured to enable information from the controlling circuitry 23, such as the service information 37, to be transmitted via the transceiver 33.

FIG. 4 schematically illustrates an example user device 5, 7 which may be used in implementations of the disclosure. The user device 5, 7 may comprise an apparatus 21 and a transceiver 33. It is to be appreciated that only features necessary for the following description have been illustrated in FIG. 4. It is to be appreciated that other features may be included in other examples. For instance, in examples where the user device is a mobile phone or a tablet computer the user device 5, 7 may also comprise other features such as displays, cameras, loudspeakers, microphones and other features.

The user device 5, 7 may comprise any means which may be configured to provide a service to a user via an accessory device 15. The user device 5, 7 may be configured to access the service via a communication network 9 and a server 3. The service could be a content rendering service such as a music or media service or any other suitable service.

The user device 5, 7 could be a device such as a mobile cellular telephone, a tablet computer, a personal computer, a camera, a gaming device, a personal digital assistant, an electronic book reader, a personal music player, a television, a non-cellular device or any other suitable electronic device. The user device 5, 7 may be a handheld user device 5, 7 which can be carried in a user's hand or bag. The user device 5, 7 may be a hand held device such that it is sized and shaped so that the user can hold the user device 5, 7 in their hand while they are using the user device 5, 7. The user device 5, 7 may be a mobile device so that the user can change location while they are using the device 5, 7.

The apparatus 21 comprised within the user device 5, 7 of FIG. 4 may be as illustrated in FIG. 2 and described above. Corresponding reference numerals are used for corresponding features.

As described above the apparatus 21 comprises controlling circuitry 23. The controlling circuitry 23 comprises memory circuitry 27 and processing circuitry 25. The memory circuitry 27 may be configured to store a computer program 29 comprising computer program code 31.

The memory circuitry 27 may be configured to store service information 41. The service information 41 may comprise any information which may enable the user devices 5, 7 to provide a service. For instance the service information 41 may comprise content which may be stored in the memory circuitry 27 of the user device 5, 7. In some examples the service information 41 may be obtained from a remote apparatus such as a server 3.

The user device 5, 7 may be registered to a user account 35 which may enable the user device 5, 7 to be used to access the service. In such examples the service information may comprise information which enables the user device to access the user account 35.

The service information 41 may comprise status information 43. The status information 43 may comprise information relating to the service which is currently being provided by the user device 5, 7. For instance, where the service being provided is a music service, the status information may include information relating to the music track currently being played and the position within the track.

In some examples the status information 43 may include information which indicates whether or not an accessory device 15 is connected to the user device 5, 7. The status information 43 may include whether or not the accessory device 15 is connected via a wireless connection 17. In some examples the status information may comprise identification information of the accessory device 15 which is connected to the user device 5, 7. In some examples the status information 43 may also include one or more performance indicators of a wireless connection 17 between the user device 5, 7 and an accessory device 15.

The transceiver 33 is illustrated as a single component in FIG. 4 however it is to be appreciated that the transceiver 33 may comprise one or more transmitters and/or receivers. The transceiver 33 may comprise any means which enables the user device 5, 7 to establish a communication link 13 with a communication network 9 and exchange information with the communication network 9. The communication link 13 may comprise a wireless connection.

In some examples the transceiver 33 may enable the user device 5, 7 to establish a wireless connection 17 with one or more accessory devices 15. The wireless connection 17 may comprise a short range wireless connection such as a Bluetooth, Bluetooth Low Energy or any other suitable type of wireless connection.

The transceiver 33 may be configured to provide information obtained via the transceiver 33 to the controlling circuitry 23. The transceiver 33 may also be configured to enable information from the controlling circuitry 23, such as the service information 41, to be transmitted via the transceiver 23.

FIG. 5 schematically illustrates an example accessory device 15 which may be used in implementations of the disclosure. The accessory device 15 may comprise an apparatus 21, a transceiver 33 and a user interface 51. It is to be appreciated that only features necessary for the following description have been illustrated in FIG. 5. It is to be appreciated that other features may be used in other examples.

The accessory device 15 may be used in combination with a user device 5, 7 to enable a service to be provided to a user. In some examples the accessory device 15 could be a headset, a loudspeaker, a head mounted display, earphones, a television, a stereo system, a watch, a mouse, a keyboard or any other suitable accessory device 15.

In some examples the accessory device 15 may be wearable by the user, for example the accessory device 15 may comprise a mounting portion which enables the accessory device 15 to be attached to the user. For example a head mounted display may comprise ear pieces which enable the display to be worn in the manner of glasses. In some examples the accessory device 15 may comprise a larger device such as a television or loudspeaker which is not intended to be moved during use.

The apparatus 21 comprised within the accessory device 15 of FIG. 5 may be as illustrated in FIG. 2 and described above. Corresponding reference numerals are used for corresponding features.

As described above the apparatus 21 comprises controlling circuitry 23. The controlling circuitry 23 comprises memory circuitry 27 and processing circuitry 25. The memory circuitry 27 may be configured to store a computer program 29 comprising computer program code 31.

The memory circuitry 27 may be configured to store identification information 53. The identification information 53 may be used to establish a wireless connection between the accessory device 15 and one or more user devices 5, 7. The identification information 53 may be provided to the one or more user devices 5, 7 to enable the user devices 5, 7 to identify the accessory device 15 to other devices. Identification information 53 may comprise a Bluetooth™ address, link key information, pairing status information or any other suitable type of information.

The transceiver 33 is illustrated as a single component in FIG. 5 however it is to be appreciated that the transceiver 33 may comprise one or more transmitters and/or receivers. The transceiver 33 may comprise any means which enables the accessory devices 15 to establish a wireless connection 17 with one or more user devices 5, 7. The wireless connection 17 may comprise a short range wireless connection such as a Bluetooth™, Bluetooth™ Low Energy or any other suitable type of wireless connection.

The transceiver 33 may be configured to provide information obtained via the transceiver 33 to the controlling circuitry 23. The transceiver 33 may also be configured to enable information from the controlling circuitry 23, such as the identification information 53, to be transmitted via the transceiver 33.

The accessory device 15 also comprises a user interface 51. The user interface 51 may comprise any means which enables an output to be provided to a user and/or which enables a user to make a user input.

For example, the user interface 51 may comprise an output device such as a loudspeaker. The loudspeaker may comprise any means which may be configured to provide an acoustic signal. The loudspeaker may be provided as a headset or ear piece or other device which may be worn by the user or positioned close to the ears of the user. In some examples the loudspeaker may comprise a larger speaker which may be, for example, part of a stereo system.

In some examples the user interface 51 may comprise an output device such as a display. The display may comprise any means which may enable content or information to be displayed. The display could be a head mounted display or part of a watch or other device which is intended to be worn by a user. In other examples the display may comprise part of a television or other device.

In some examples the user interface 51 may comprise a user input device. The user input device may comprise any means which enable a user to input commands and control the accessory device 15 or a user device 5, 7. For example, the user input device may comprise a mouse or a keyboard or any other suitable means.

FIGS. 6A to 6C illustrate methods according to examples of the disclosure. The methods may be implemented using the system 1 and apparatus 21 as described above.

FIG. 6A illustrates a method which may be carried out by a first user device 5. At block 55 a wireless connection 17 is established between the first user device 5 and an accessory device 15. The wireless connection 17 may be a short range wireless connection. As an example a user may be using the using the user device 5 and an accessory device 15 such as a headset to listen to music. The user device 5 may be registered to a user account 35 associated with the service.

At block 56 it is determined whether or not a trigger event has been detected. The trigger event could be any event which may cause a new wireless connection to be established with another user device 7. The trigger event may comprise a change in the status of the user device 5 and/or the user of the user device 5.

In some examples the trigger event may comprise a change in the wireless connection 17 between the user device 5 and the accessory device 15. In such examples a performance level of the wireless connection 17 between the first user device 5 and the accessory device 15 may be monitored. If the performance level falls below a predetermined threshold then at block 56 this could be a new trigger event.

In some examples the trigger event could be that the user of the user device 5 has now moved closer to a different user device 7 and/or started to use a different user device 7. For instance the user may have picked up or turned on another user device 7 such as a tablet.

It is to be appreciated that other trigger events could be used in other examples of the disclosure. For instance the accessory device 15 could detect another user device 7 and provide a notification of the another user device 7.

If no trigger event is detected then the method returns to block 55 and the service continues to be provided using the first user device 5. If a trigger event is detected then the method proceeds to block 57.

At block 57 the user device 5 provides status information 43 to the server 3. The status information 43 may comprise information which enables a second user device 7 to establish a wireless connection with the accessory device 15.

The status information 43 may comprise information which enables a second user device 7 to establish a wireless connection with the accessory device 15 without interrupting the service being provided to the user. The status information 43 may comprise information which enables a fast handover of the accessory device 15.

The status information 43 may comprise information relating to the service currently being provided. For example the status information 43 may include information relating to a music track currently being provided or the source of the current music track, such as a web address.

In some examples the status information 43 may include information relating to the current status of the user device, for example whether or not the display is currently activated or not.

In some examples the status information 43 includes information relating to the accessory device 15 which is currently connected to the second user device. Such information may comprise information which enables the accessory device to be identified by other user devices 7.

FIG. 6B illustrates a method which may be carried out by a second user device 7. At block 58 a connection is established with a server 3. The user device 7 may be registered to the same user account 35 as the first user device 5.

At block 59 it is determined whether or not a trigger event has been detected. The trigger event could be any event which may cause a new wireless connection to be established with another user device 7. The trigger event may comprise a change in the status of a user device 5, 7 and/or the user of the user device. The trigger event may be as described above with relation to FIG. 6A.

If no trigger event is detected then the method returns to block 58 and the connection to the server 3 and user account 35 is maintained. If a trigger event is detected then the method proceeds to block 60.

At block 60 the user device 7 obtains status information 43 from the server 3. The status information 43 may comprise information which enables a second user device 7 to establish a wireless connection with the accessory device 15. The status information 43 may comprise information which enables a second user device 7 to establish a wireless connection with the accessory device 15 without interrupting the service being provided to the user. The status information 43 may comprise information which has been received by the server 3 from the first user device 5. As mentioned above the status information 43 may comprise information relating to the service currently being provided and/or information relating to the accessory device 15 or any other suitable information. The status information 43 may include information relating to the status of the first user device 5 and/or other user devices.

At block 61 it is determined whether or not a wireless connection is to be established between the second user device 7 and the accessory device 15. In some examples the second user device 7 may send a notification to the server 3 that the second user device 7 may be willing to establish a connection to a new accessory device 15.

If no new wireless connection is to be established then the method returns to block 58. If a new wireless connection is to be established then at block 62 a new wireless connection is established between the second user device 7 and the accessory device 15. After the wireless connection is established the service is provided using the second user device 7 and the accessory device 15.

The status information 43 may comprise identification information of the accessory device 15 which may enable the wireless connection to be set up. For example the status information 43 may comprise identification information, link key information or pairing status information, connectivity information of the accessory device or any other suitable information.

The status information 43 may comprise information relating to the service currently being provided so that the second user device 7 can carry on providing the service from the same point at which the first user device 5 was providing the service when the handover occurred. This may enable the accessory device 15 to switch between user devices 5, 7 without interrupting the service being provided to the user.

In some examples once the wireless connection between the second user device 7 and the accessory device 15 has been established the wireless connection 17 between the first user device 5 and the accessory device 15 may be discontinued. In other examples the wireless connection 17 between the first user device 5 and the accessory device 15 may be maintained, this may enable the user to switch back to using the first user device 5 if needed.

In some examples the status information 43 may include information relating to a plurality of accessory devices 15 which are currently connected to the first user device 5. The second user device 7 may determine which of the accessory devices 15 the second user device 7 should be connected to.

FIG. 6C illustrates a method which may be carried out by a server 3. At block 63 a service is provided. A plurality of user devices 5, 7 may be registered to the same user account 35 for the service. The user devices 5, 7 may also be registered to different user accounts 35. The server 3 may use a communication network 9 to maintain connections between a plurality of user device 5, 7.

At block 64 the server obtains status information 43 from a first user device 5. The status information 43 may be sent by the first user device 5 in response to a trigger event as described above. The status information 43 may comprise information which enables a second user device 7 to establish a wireless connection with the accessory device 15.

At block 65 the server 3 may determine whether or not a new connection between a different user device 7 and the accessory device 15 is needed. If it is not needed then the method returns to block 63. If a new connection is needed then at block 66 the server 3 sends the status information 43 to the second user device 7 to enable the second user device 7 to establish a new connection.

Where there are more than two user devices 5, 7 registered to the same user account 35 then at block 64 the server 3 may decide which of the other user devices 5, 7 the status information 43 should be sent to. In some examples the server 3 may decide which of the other user devices 5, 7 should be used to establish a new connection to the accessory device 15.

In the example of FIG. 6C the server 3 may determine whether or not a new connection should be established with the accessory device 15. In other examples the user devices 5, 7 may determine that the new connection is needed. In some examples the new connection may be established in response to a user input. For instance, one or more of the user devices 5, 7 may provide a user selectable option to a user to enable a user to indicate if they would like to switch the accessory device 15 to another user device 7.

FIG. 7 illustrates another example method. The method may be performed using an apparatus 21 as described above. The apparatus 21 may be comprised within a server 3 or any other suitable device. The method of FIG. 7 comprises, at block 71, causing a service to be provided using a first user device 5 and an accessory device 15 wherein the accessory device 15 is connected to the first user device 5 via a wireless connection 17 and wherein a plurality of user devices 5, 7 are registered to a user account 35.

The method of FIG. 7 also comprises, at block 73, obtaining status information from the first user device 5 and, at block 75 determining a trigger event has occurred. In response to determining that a trigger event has occurred the method comprises enabling a second user device 7 to establish a wireless connection to the accessory device 15.

FIG. 8 illustrates another example method. The method may be performed using an apparatus 21 as described above. The apparatus 21 may be comprised within a user device 5 as described above or any other suitable device. The method of FIG. 8 comprises, at block 81 enabling a service to be provided using an accessory device 15 wherein the accessory device 15 is connected to the apparatus 21 via a wireless connection. The service is enabled using a server 3 and a plurality of user devices 5, 7 are registered to a user account 35 for the service. The method also comprises, at block 83, providing status information 43 to the server 3 wherein the status information 43 enables another user device, registered to the user account for the service, to establish a wireless connection 17 to the accessory device 15.

FIG. 9 illustrates another example method. The method may be performed using an apparatus 21 as described above. The apparatus 21 may be comprised within a user device 7 as described above or any other suitable device. The method of FIG. 9 comprises, at block 91 enabling communication with a server 3 wherein the server 3 is configured to cause a service to be provided using a first user device 5 and an accessory device 15 wherein the accessory device 15 is connected to the first user 5 device via a wireless connection 17 and wherein a plurality of user devices 5, 7 are registered to a user account 35 for the service. At block 93 the method comprises obtaining status information from the server 3 and at block 95 determining that a trigger event has occurred and in response to determining that a trigger event has occurred establishing a wireless connection to the accessory device 15.

The blocks illustrated in the FIGS. 6A to 9 may represent steps in a method and/or sections of code in the computer program 29. The illustration of a particular order to the blocks does not necessarily imply that there is a required or preferred order for the blocks and the order and arrangement of the block may be varied. Furthermore, it may be possible for some blocks to be omitted.

The methods and apparatus 21 described above enable an accessory device 15 to be handed between user devices 5, 7 without interrupting the service being provided to a user. The server 3 and/or the information stored in the server 3 may be used to enable the new connection to be established and the service to be provided without interruption.

Where a structural feature has been described, it may be replaced by means for performing one or more of the functions of the structural feature whether that function or those functions are explicitly or implicitly described.

In some examples there may be provided an apparatus 21 comprising: means for causing a service to be provided using a first user device 5 and an accessory device 15 wherein the accessory device 15 is connected to the first user device 5 via a wireless connection 17 and wherein a plurality of user devices are registered to a user account 35 for the service; means for obtaining status information from the first user device 5; and means for providing the obtained status information to a second user device 7 wherein the second user device 7 is registered to the user account 35 for the service and the obtained status information enables the second user device 7 to establish a wireless connection to the accessory device 15.

The term “comprise” is used in this document with an inclusive not an exclusive meaning. That is any reference to X comprising Y indicates that X may comprise only one Y or may comprise more than one Y. If it is intended to use “comprise” with an exclusive meaning then it will be made clear in the context by referring to “comprising only one.” or by using “consisting”.

In this brief description, reference has been made to various examples. The description of features or functions in relation to an example indicates that those features or functions are present in that example. The use of the term “example” or “for example” or “may” in the text denotes, whether explicitly stated or not, that such features or functions are present in at least the described example, whether described as an example or not, and that they can be, but are not necessarily, present in some of or all other examples. Thus “example”, “for example” or “may” refers to a particular instance in a class of examples. A property of the instance can be a property of only that instance or a property of the class or a property of a sub-class of the class that includes some but not all of the instances in the class. It is therefore implicitly disclosed that a features described with reference to one example but not with reference to another example, can where possible be used in that other example but does not necessarily have to be used in that other example.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

I/We claim:

1. An apparatus comprising:
processing circuitry; and
memory circuitry including computer program code;
the memory circuitry and the computer program code configured to, with the processing circuitry, cause the apparatus at least to,
cause a service to be provided using a first user device and an accessory device wherein the accessory device is connected to the first user device via a wireless connection and wherein a plurality of user devices are registered to a user account;
determine that a trigger event has occurred, wherein the trigger event comprises obtaining information indicating that a user is using a second user device registered to the same user account as the plurality of user devices; and
enable the second user device to establish a wireless connection to the accessory device in response to the determination that the trigger event has occurred.

2. (canceled)

3. An apparatus as claimed in claim 1, wherein the memory circuitry and the computer program code are further configured to, with the processing circuitry, cause the apparatus to cause the service to be provided using the second user device and the accessory device after the wireless connection is established between the second user device and the accessory device.

4. (canceled)

5. (canceled)

6. An apparatus as claimed in claim 1, wherein the memory circuitry and the computer program code are further configured to, with the processing circuitry, cause the apparatus to obtain information relating to a performance level of the wireless connection between the first user device and the accessory device, and
wherein the trigger event comprises detecting that the wireless connection between the first user device and the accessory device falls below a predetermined level.

7. (canceled)

8. (canceled)

9. (canceled)

10. (canceled)

11. An apparatus as claimed in claim 1, wherein the memory circuitry and the computer program code are further configured to, with the processing circuitry, cause the apparatus to be connected to the first and second user devices via an internet connection.

12. (canceled)

13. A server comprising an apparatus as claimed in claim 1.

14. A method comprising:
causing a service to be provided using a first user device and an accessory device wherein the accessory device is connected to the first user device via a wireless connection and wherein a plurality of user devices are registered to a user account;
determining that a trigger event has occurred, wherein the trigger event comprises obtaining information indicating that the user is using a second user device registered to the same user account as the plurality of user devices; and
enabling a second user device to establish a wireless connection to the accessory device in response to the determination that the trigger event has occurred.

15. (canceled)

16. A method as claimed in claim 14, further comprising causing the service to be provided using the second user device and the accessory device after the wireless connection is established between the second user device and the accessory device.

17. (canceled)

18. (canceled)

19. A method as claimed in claim 14, further comprising obtaining information relating to a performance level of the wireless connection between the first user device and the accessory device, wherein the trigger event comprises detecting that the performance level of the wireless connection between the first user device and the accessory device falls below a predetermined level.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. A method comprising:
communicating with a server, wherein the server is configured to cause a service to be provided using a first user device and an accessory device, wherein the accessory device is connected to the first user device via a wireless connection and wherein an apparatus and the first user device are registered to a same user account for the service;
obtaining status information from the server; and
establishing a wireless connection to the accessory device in response to determination that a trigger event has occurred, wherein the trigger event comprises obtaining information indicating that the user is using the apparatus.

36. (canceled)

37. A method as claimed in claim 35, wherein after the wireless connection is established with the accessory device, the service is provided using the apparatus and the accessory device.

38. (canceled)

39. (canceled)

40. (canceled)

41. (canceled)

42. (canceled)

43. (canceled)

44. A computer program product comprising computer executable program code recorded on a computer readable, non-transitory storage medium, the computer executable program code comprising:
code for causing a service to be provided using a first user device and an accessory device wherein the accessory device is connected to the first user device via a wireless connection and wherein a plurality of user devices are registered to a user account;
code for determining that a trigger event has occurred, wherein the trigger event comprises obtaining information indicating that the user is using a second user device registered to the same user account as the plurality of user devices; and
code for enabling a second user device to establish a wireless connection to the accessory device in response to the determination that the trigger event has occurred.

45. A computer program product as claimed in claim 44, further comprising code for causing the service to be provided using the second user device and the accessory device after the wireless connection is established between the second user device and the accessory device.

46. A computer program product as claimed in claim 44, further comprising code for obtaining information relating to a performance level of the wireless connection between the first user device and the accessory device, wherein the trigger event comprises detecting that the performance level of the wireless connection between the first user device and the accessory device falls below a predetermined level.

47. An apparatus comprising:
processing circuitry; and
memory circuitry including computer program code;
the memory circuitry and the computer program code configured to, with the processing circuitry, cause the apparatus at least to perform;
communicate with a server, wherein the server is configured to cause a service to be provided using a first user device and an accessory device, wherein the accessory device is connected to the first user device via a wireless connection and wherein the apparatus and the first user device are registered to a same user account for the service:
obtain status information from the server; and
establish a wireless connection to the accessory device in response to determination that a trigger event has occurred, wherein the trigger event comprises obtaining information indicating that a user is using the apparatus.

48. An apparatus as claimed in claim 47, wherein after the wireless connection is established with the accessory device, the service is provided using the apparatus and the accessory device.

49. A computer program product comprising computer executable program code recorded on a computer readable, non-transitory storage medium, the computer executable program code comprising:
code for communicating with a server, wherein the server is configured to cause a service to be provided using a first user device and an accessory device, wherein the accessory device is connected to the first user device via a wireless connection and wherein an apparatus and the first user device are registered to a same user account for the service;
code for obtaining status information from the server; and
code for establishing a wireless connection to the accessory device in response to determination that a trigger event has occurred, wherein the trigger event comprises obtaining information indicating that a user is using the apparatus.
